(19) United States
(12) Patent Application Publication
(10) Pub. No.: US 2023/0161035 A1
(43) Pub. Date: May 25, 2023

(54) DETECTION DEVICE AND METHOD

(71) Applicant: NINGBO ABAX SENSING CO., LTD., Ningbo City (CN)

(72) Inventor: Shuyu LEI, Ningbo City, Zhejiang Province (CN)

(73) Assignee: Ningbo ABAX Sensing Electronic Technology Co., Ltd., Ningbo City (CN)

(21) Appl. No.: 17/910,929

(22) PCT Filed: Dec. 15, 2020
(86) PCT No.: PCT/CN2020/136582

§ 371 Date: Sep. 12, 2022

(30) Foreign Application Priority Data
Mar. 16, 2020 (CN) 202010179897.4
Mar. 16, 2020 (CN) 202010184409.9

(51) Int. Cl. G01S 17/10; G01S 7/4865; G01S 7/484

(52) U.S. Cl. CPC G01S 17/10; G01S 7/4866; G01S 7/484

(57) ABSTRACT

A detection device, characterized in that a light emitting module (110) comprises at least two emitting areas, and a light receiving module (130) comprises at least two receiving areas corresponding to the light emitting module (110); a processing module (120) can generate a first instruction to be electrically connected to all emitting units, so that all the emitting units simultaneously output emitted light, and all the receiving units of the light receiving module (130) correspond to the emitting units on a one-to-one basis; and the processing module (120) can also generate an instruction different from the first instruction to only be electrically connected to some of the emitting units, so that the light emitting module (110) outputs emitted light once or more than once, and the light receiving module (130) obtains reflected light information of a target area once or more than once. The self-adaptive emitting method focuses energy on a smaller field angle, thereby improving the power density; and all or some of the emitting units emit light once or multiple times, thereby adapting to different measurement scenarios and expanding application scenarios of the device.

### CROSS REFERENCE TO RELATED APPLICATIONS

This application claims priority to Chinese Patent Application No. CN202010184409.9, titled “DETECTION DEVICE AND METHOD”, filed on Mar. 16, 2020 with the Chinese Patent Office, and Chinese Patent Application No. CN202010179897.4, titled “DETECTION DEVICE AND METHOD”, filed on Mar. 16, 2020 with the Chinese Patent Office, both of which are incorporated herein by reference in their entireties.

### FIELD

The present disclosure relates to the technical field of detection, and in particular to a detection device and a detection method.

### BACKGROUND

The principle of the Time of flight (TOF) distance measurement method is that, a light pulse is continuously emitted to a target, and a light returned from the target is received by a sensor, and the distance to the target is obtained by detecting the flight (round-trip) time of the light pulse.

The Direct Time of Flight (DTOF) is a kind of the TOE In the DTOF technology, the target distance is directly acquired by calculating the emission time and the reception time of the light pulse, having the advantages of simple principle, high signal-to-noise ratio, high sensitivity and accuracy, and thus has attracted more and more attention. Similarly, a high-precision and high-sensitivity distance detection can be achieved with the ITOF solution.

However, with the increasing demand for the detection distance, the existing DTOF or ITOF technology has the problem that the detection distance is not far enough and cannot be adjusted adaptively.

### SUMMARY

In view of the above, an object of the present disclosure is to provide a detection device and a detection method to solve the technical problems in the conventional technology that the detection distance of the existing detection device is not far enough and the detection system cannot be adaptively adjusted.

In order to achieve the above object, solutions in the embodiments of the present disclosure are provided.

In a first aspect, a detection device is provided according to an embodiment of the present disclosure. The detection device includes: a light emitting module, a processing module and a light receiving module. The light emitting module has at least two emitting regions, and the light receiving module has at least two receiving regions corresponding to the light emitting module. The processing module is configured to generate a first instruction to be electrically connected to all emitting units so that all the emitting units simultaneously output emitted light, where receiving units of the light receiving module are in one-to-one correspondence with the emitting units, and the processing module is configured to calculate distance data of a detected target according to data of the light receiving module. The processing module is further configured to generate an instruction different from the first instruction to be electrically connected to some of the emitting units so that the light emitting module outputs the emitted light once or more than once, and the light receiving module is configured to acquire reflected light information of a target region once or more than once, and the processing module is configured to acquire data of the receiving regions once or more than once, and calculate the distance data of the detected target including the reflected light information once or more than once.

Optionally, the processing module is configured to generate an emitting sequence instruction. The light emitting module is electrically connected to the processing module and is configured to control, according to the emitting sequence instruction generated by the processing module, the at least two emitting regions to sequentially output the emitted light. The light receiving module is electrically connected to the processing module and is configured to control, according to an emitting sequence instruction generated by the processing module, the at least two receiving regions to receive the reflected light of the emitted light for at least two times that is reflected from the detected target. The processing module is configured to: sequentially acquire the data of the at least two receiving regions according to the emitting sequence instruction, and calculate the distance data of the detected target including the reflected light information for at least two times.

Optionally, the light emitting module includes one emitting array, and the emitting array is divided into at least two emitting modules, and each of the emitting modules serves as one of the emitting regions; or
the light emitting module includes at least two emitting arrays, and each of the emitting arrays serves as one of the emitting regions.

Optionally, the processing module is configured to generate the emitting sequence instruction according to at least one of a function, a list, a number sequence or a randomly generated sequence.

Optionally, the processing module is further configured to: determine the receiving region corresponding to the reflected light each time according to the emitting sequence instruction, as a target receiving region; and acquire at least a part of target distance information according to time information of the target receiving region receiving the reflected light.

Optionally, the processing module is further configured to: set, according to the target receiving region, received signals of other receiving regions among the receiving regions than the target receiving region as a preset value.

Optionally, the processing module is configured to generate a detected target map according to the emitting sequence instruction and a time when the reflected light is received each time, where the detected target map includes all distance data of the detected target.

Optionally, the light emitting module is further configured to control, according to the emitting sequence instruction, one or more of the emitting regions to output the emitted light each time.

Optionally, the processing module is configured to generate the first instruction or the instruction different from the first instruction according to distance information of the detected target.

Optionally, the distance information of the detected target is historical detection distance information, and where in the detection device, the processing module is electrically connected to the light emitting module according to the first instruction or the instruction different from the first instruction, so that the light emitting module outputs the emitted light once or more than once, and the processing device is configured to acquire the data received by the light receiving device, and calculate the historical detection distance information.

Optionally, the multiple emitting units are divided into at least two emitting regions, and the multiple receiving units are divided into at least two corresponding receiving regions.

Optionally, multiple emitting units in a same emitting region are electrically connected to the processing module under the instruction different from the first instruction to output the emitted light at different times.

In a second aspect, a detection method is provided according to an embodiment of the present disclosure. The detection method includes: a light emitting module, a processing module and a light receiving module, the light emitting module having at least two emitting regions, the light receiving module having at least two receiving regions corresponding to the light emitting module. The processing module is capable of generating a first instruction to be electrically connected to all emitting units so that all the emitting units simultaneously output emitted light, where receiving units of the light receiving module are in one-to-one correspondence with the emitting units, and the processing module calculates distance data of a detected target according to data of the light receiving module. The processing module is further capable of generating an instruction different from the first instruction to be electrically connected to some of the emitting units so that the light emitting module outputs the emitted light once or more than once, and the light receiving module acquires reflected light information of a target region once or more than once, and the processing module acquires data of the receiving regions once or more than once, and calculates the distance data of the detected target including the reflected light information once or more than once.

Optionally, the processing module generates an emitting sequence instruction. The light emitting module is electrically connected to the processing module and is configured to control, according to the emitting sequence instruction generated by the processing module, the at least two emitting regions to sequentially output the emitted light. The light receiving module is electrically connected to the processing module and is configured to control, according to an emitting sequence instruction generated by the processing module, the at least two receiving regions to receive the reflected light of the emitted light for at least two times that is reflected from the detected target. The processing module is configured to: sequentially acquire the data of the at least two receiving regions according to the emitting sequence instruction, and calculate the distance data of the detected target including the reflected light information for at least two times.

Optionally, the light emitting module includes one emitting array, and the emitting array is divided into at least two emitting modules, and each of the emitting modules serves as one of the emitting regions; or
the light emitting module includes at least two emitting arrays, and each of the emitting arrays serves as one of the emitting regions.

Optionally, the processing module is configured to generate the emitting sequence instruction according to at least one of a function, a list, a number sequence or a randomly generated sequence.

Optionally, the processing module is further configured to: set, according to the target receiving region, received signals of other receiving regions among the receiving regions than the target receiving region as a preset value.

Optionally, the processing module generates the first instruction or the instruction different from the first instruction according to distance information of the detected target.

Optionally, the distance information of the detected target is historical detection distance information, and where in the detection device, the processing module is electrically connected to the light emitting module according to the first instruction or the instruction different from the first instruction, so that the light emitting module outputs the emitted light once or more than once, and the processing device acquires the data received by the light receiving device and calculates the historical detection distance information.

Optionally, the processing module is configured to generate a detected target map according to the emitting sequence instruction and a time when the reflected light is received each time, where the detected target map includes all distance data of the detected target.

A detection device and a detection method are provided according to the embodiments of the present disclosure. The detection device includes: a light emitting module, a processing module, and a light receiving module. The light emitting module includes multiple emitting units, and the light receiving module includes multiple receiving modules unit. The processing module may generate a first instruction to be electrically connected to all emitting units so that all the emitting units simultaneously output emitted light, all receiving units of the light receiving module are in one-to-one correspondence with the emitting units. The processing module calculates distance data of a detected target according to data of the light receiving module. In addition, the processing module may generate an instruction different from the first instruction to be electrically connected to only some of the emitting units, so that the light emitting module outputs the emitted light once or more than once, and the light receiving module acquires reflected light information of a target region once or more than once, and the processing module acquires data of the receiving regions once or more than once, and calculates the distance data of the detected target including the reflected light information once or more than once. In this way, the self-adaptive emission of the light emitting module can be achieved, which concentrates the energy that originally occupied the entire field of view in a smaller field of view, achieves the concentration of energy, and improves the power density. Therefore, the detection distance of the detection device can be increased to a certain extent, and the applicability of the detection device can be improved. On the other hand, all or some of the emitting units can emit light one or more times according to different instructions, which realizes the adaptation to different measurement scenarios and expands the application scenarios of the detection device.

### BRIEF DESCRIPTION OF THE DRAWINGS

In order to illustrate technical solutions of the present disclosure more clearly, the drawings used for the embodiments are briefly introduced in the following. It should be understood that the drawings show only some embodiments of the present disclosure, and should not be regarded as a limitation of the scope. Other drawings may be obtained by those skilled in the art from these drawings without any creative work.

FIG. 1 is a schematic diagram showing functional modules of a detection device according to an embodiment of the present disclosure;

FIG. 2 is a schematic diagram showing divisional emission according to an embodiment of the present disclosure;

FIG. 3 is a schematic diagram showing an emitting region according to an embodiment of the present disclosure;

FIG. 4 is a schematic diagram showing an emitting region according to another embodiment of the present disclosure;

FIG. 5 is a schematic diagram showing an emitting region according to another embodiment of the present disclosure;

FIG. 6 is a schematic diagram showing divisional emission according to another embodiment of the present disclosure;

FIG. 7 is a schematic flowchart of a detection method according to an embodiment of the present disclosure;

FIG. 8 is a schematic flowchart of a detection method according to another embodiment of the present disclosure; and

FIG. 9 is a schematic flowchart of a detection method according to another embodiment of the present disclosure.

### DETAILED DESCRIPTION OF EMBODIMENTS

In order to make objects, technical solutions and advantages of the embodiments of the present disclosure clearer, the technical solutions in the embodiments of the present disclosure are clearly and completely described below with reference to the drawings in the embodiments of the present disclosure. Apparently, the described embodiments are some but not all embodiments of the present disclosure. Components of the embodiments generally described and illustrated in the drawings herein may be arranged and designed in a variety of different configurations.

Therefore, the following detailed description for the embodiments of the present disclosure provided in the drawings is not intended to limit the scope of the present disclosure as claimed, but is merely representative of selected embodiments of the present disclosure. Based on the embodiments in the present disclosure, all other embodiments obtained by those of ordinary skill in the art without creative work shall fall in the protection scope of the present disclosure.

It should be noted that, similar numerals and letters refer to similar items in the following drawings. Therefore, if an item is defined in a drawing, the item is not required to be further defined and explained in subsequent drawings.

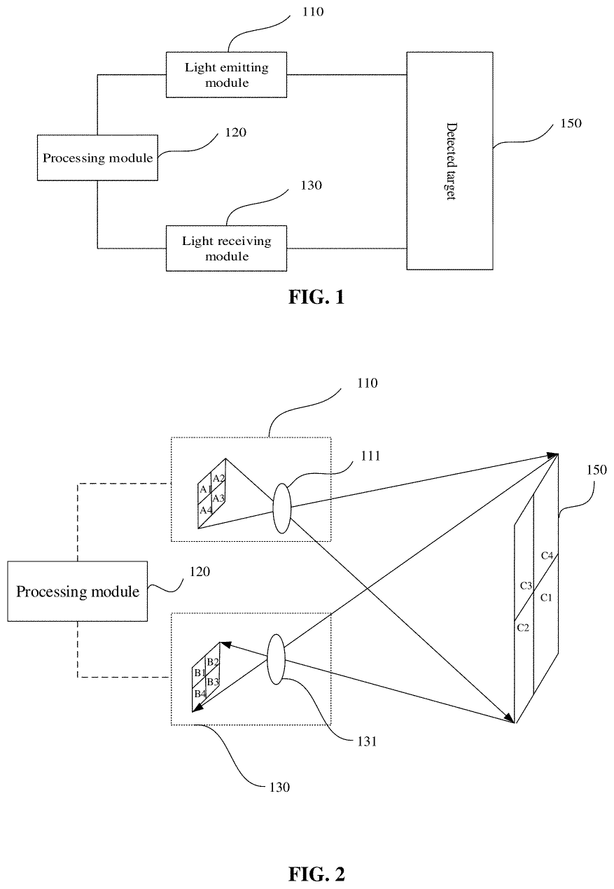

FIG. 1 is a schematic diagram showing functional modules of a detection device according to an embodiment of the present disclosure. As shown in FIG. 1, the detection device includes: a light emitting module 110, a processing module 120 and a light receiving module 130. The light emitting module 110 includes multiple emitting units, and the light receiving module 130 includes multiple receiving units corresponding to the light emitting module 110.

The processing module 120 is configured to generate a first instruction or an instruction different from the first instruction. The first instruction may be used to cause all the emitting units to simultaneously output emitted light. All the receiving units of the light receiving module 130 are in one-to-one correspondence with the emitting units. The processing module is configured to calculate distance data of a detected target according to data of the receiving module. The instruction different from the first instruction is used to cause the processing module 120 to be electrically connected to only some of the emitting units, so that the light emitting module 110 outputs the emitted light once or more than once. The light receiving module 130 is configured to acquire reflected light information of a target region once or more than once, and the processing module 120 is configured to acquire data of the receiving regions once or more than once, and calculate the distance data of the detected target including the reflected light information once or more than once. For example, the processing module 120 generates a second instruction, and the processing module 120 is electrically connected to some of the light emitting units according to the second instruction. The light emitting module 110 outputs the emitted light once, the light receiving module 130 acquires the reflection information of the target region once, and the processing module 120 acquires the data once, and calculates and outputs the distance to the target. In this case, the detected target is relatively close, and only fewer emitting units are required to output the emitted light once, achieving low-power distance measurement. In addition, the processing module 120 generates a third instruction, and the processing module 120 is electrically connected to some of the light emitting units according to the third instruction. The light emitting module 110 outputs the emitted light no less than twice, the light receiving module 130 acquires the reflection information of the target region two or more times, and the processing module 120 acquires the data no less than twice, and calculates and outputs the distance to the target. In this case, the detected target is relatively far, and fewer emitting units are required to output the emitted light no less than twice, and the energy is concentrated on some of the emitting units, increasing the distance range of laser ranging under the condition of low power or maximum power limit, and enhancing the resistance of the detection system to environmental interference.

The light emitting module 110 may be electrically connected to the processing module 120, and is configured to control, according to an emitting sequence instruction generated by the processing module 120, at least two emitting regions to sequentially output the emitted light. The light receiving module 130 may be electrically connected to the processing module 120, and is configured to control, according to the emitting sequence instruction generated by the processing module 120, at least two receiving regions to receive the reflected light of the emitted light for at least two times that is reflected from the detected target 150.

In the work process of the detection system, whether the processing module generates the first instruction or the instruction different from the first instruction may be determined based on distance information of the detected target. The distance information may be historical detection distance information. The historical distance information may be acquired by a process similar to adaptive pre-detection of the ranging process. That is, the detection device may electrically connect the processing module 120 with the light emitting module 110 according to the first instruction or the instruction different from the first instruction, and the light emitting module 110 outputs the emitted light once or more than once, and the processing module 120 acquires the data received by the light receiving device, calculates the historical detection distance information. Alternatively, the detection device is firstly activated in a predetermined manner according to a preset function table or similar empirical data, and the instruction of the detection system is adaptively adjusted in the actual detection process.

Further, as shown in FIG. 1, the detection device includes: the light emitting module 110, the processing module 120, and the light receiving module 130. The light emitting module 110 has at least two emitting regions, and the light receiving module 130 has at least two receiving regions corresponding to the light emitting module 110.

The processing module 120 is configured to generate the emitting sequence instruction. The emitting sequence instruction may be used to indicate an emitting sequence of the at least two emitting regions in the light emitting module 110, which may be sequential emission, random emission, and the like.

The light emitting module 110 may be electrically connected to the processing module 120, and is configured to control, according to an emitting sequence instruction generated by the processing module 120, the at least two emitting regions to sequentially output the emitted light. The light receiving module 130 may be electrically connected to the processing module 120, and is configured to control, according to the emitting sequence instruction generated by the processing module 120, the at least two receiving regions to receive the reflected light of the emitted light for at least two times that is reflected from the detected target 150. The operation herein is performed according to the third instruction.

The light emitting module 110 may include a light source and an optical emitting element. The light source includes but is not limited to a semiconductor laser and/or a solid-state laser, and may include other types of lasers. The optical emitting element includes but is not limited to a lens, a lens group, a Fresnel lens, a zone plate and/or a reflecting mirror, and the like. The emitted light outputted by the light source may be emitted to the detected target 150 via the optical emitting element. In the embodiments of the present disclosure, the light emitting module 110 includes the at least two emitting regions, which means that the light source is divided into regions to output the emitted light. The light receiving module 130 may include a receiving array and an optical receiving element. The receiving array includes but is not limited to a photodiode array, an avalanche photodiode array and/or a single-photon avalanche photodiode array, and the like. That is, the reflected light reflected from the detected target 150 may be received by the receiving array via the optical receiving element. In the embodiments of the present disclosure, the light receiving module 130 includes the at least two receiving regions, which means that the receiving array is divided into regions to receive the reflected light reflected from the detected target 150. The at least two receiving regions may be in one-to-one correspondence with the at least emitting regions based on the reflected light.

According to the division of the emitting regions, a region of the detected target 150 may be divided. Each emitting region may have a mapping relationship with one region on the detected target 150 and correspond to one receiving region. Optionally, the number of emitting regions may be the same as the number of receiving regions, that is, one emitting region corresponds to one receiving region, and the receiving region is used to receive the reflected light of the emitted light reflected from the detected target 150. In this way, the divisional emission of the light emitting module 110 and the divisional reception of the light receiving module 130 can be achieved, so that the energy originally occupying the entire field of view is concentrated on a smaller field of view to achieve energy concentration and improve power density, facilitating longer distance detection.

The processing module 120 is configured to sequentially acquire the data of the at least two receiving regions according to the emitting sequence instruction, and calculate the distance data of the detected target including the reflected light information for at least two times.

The light emitting module 110 controls the at least two emitting regions to sequentially output the emitted light according to the emitting sequence instruction generated by the processing module 120, and the light receiving module 130 controls the at least two receiving regions to receive the reflected light of the emitted light for at least two times reflected from the detected target 150 according to the emitting sequence instruction generated by the processing module 120. In this case, when receiving, the processing module 120 may sequentially acquire the data of the at least two receiving regions according to the emitting sequence instruction, and splice the data of the at least two receiving regions according to the emitting sequence instruction to synthesize a complete distance map, so that the distance data of the detected target including the reflected light information for at least two times can be calculated, and the detection distance for the detected target can be outputted, ensuring the detection accuracy while ensuring the detection distance, and avoiding the reduction of the detection distance due to the affect of the environment (such as fog, haze and/or raindrops).

In the case that the system operates according to the second instruction described above, the light emitting module 110 controls one of the emitting regions to output the emitted light according to the emitting sequence instruction generated by the processing module 120, and the light receiving module 130 controls one of the receiving regions to receive the reflected light of the emitted light reflected from the detected target 150 according to the emitting sequence instruction generated by the processing module 120. In this case, when receiving, the processing module 120 may sequentially acquire the data of the receiving region according to the emitting sequence instruction, and calculate the data of the receiving region according to the emitting sequence instruction to complete the distance map, so that the distance data of the detected target including the reflected light information for once can be calculated, and the detection distance for the detected target can be outputted, ensuring the detection accuracy while ensuring the detection distance, and the detection power can be reduced under the instruction without affecting the detection accuracy, thereby achieving the short-distance detection by self-adaptive adjustment of the detection system.

FIG. 2 is a schematic diagram showing divisional emission according to an embodiment of the present disclosure. As shown in FIG. 2, there is a mapping relationship between the emitting region, the receiving region and the region of the detected target. For example, the light emitting module 110 may include four emitting regions including A1, A2, A3 and A4, and the light reception module 130 may include four receiving regions including B1, B2, B3 and B4. Correspondingly, the detected target 150 may be divided into four detection regions including C1, C2, C3 and C4. The following description is given by taking the emitting region A1 as an example. Optionally, the emitting region A1, the receiving region B1 and the detection region C1 may have a mapping relationship. That is, the emitted light outputted from the emitting region A1 is emitted to the detection region C1 via the optical emitting element 111 and is reflected from the detection region C1 to generate the reflected light, and the reflected light is received by the receiving region B1 via the optical receiving element 131, realizing the divisional emission and the divisional reception. The number of the emitting regions and the number of the receiving regions are not limited in the present disclosure, which may be set according to the actual application scenario. The actual corresponding relationship between the emitting end, the receiving end and the detection region is not limited to that shown in the drawings.

To sum up, the detection device provided in the embodiment of the present disclosure includes: the light emitting module, the processing module, and the light receiving module. The light emitting module includes the multiple emitting units, and the light receiving module includes the multiple receiving modules unit. The processing module may generate the first instruction to be electrically connected to all the emitting units so that all the emitting units simultaneously output the emitted light, all the receiving units of the light receiving module are in one-to-one correspondence with the emitting units. The processing module calculates the distance data of the detected target according to the data of the light receiving module. In addition, the processing module may generate the instruction different from the first instruction to be electrically connected to only some of the emitting units, so that the light emitting module outputs the emitted light once or more than once, and the light receiving module acquires the reflected light information of the target region once or more than once, and the processing module acquires the data of the receiving regions once or more than once, and calculates the distance data of the detected target including the reflected light information once or more than once. In this way, the detection system has a variety of modes, which may be automatically selected according to the detection distance or the like. For example, in a case that the detection distance is relative long, the distance data may be obtained by multiple measurements by divisional. In addition, in a case that the detection distance is relative short, the distance data may be obtained by one measurement for a single region. Furthermore, in a case that the detection distance is moderate, the distance data may be obtained by a measurement for the emitting units and the receiving units in a one-to-one correspondence once. In the specific implementation, the moderate distance may be a preset range value, or the moderate distance may be a self-adaptive dynamic value obtained according to the historical situation in the actual use, achieving real-time adjustment according to the use state, and ensuring that the system always has a high efficiency.

In addition, by the divisional emission, the pressure on the driving caused by the increase in the pulse power of the light emitting module can be reduced, the maximum instantaneous current generated when the pulse is emitted can be reduced so that the driving current can be more gentle, and the heat dissipation burden of the light emitting module can be reduced, and thus improving the heat dissipation. Further, only one region may be used in the short-distance detection to reduce the energy consumption of the whole system.

In the following, the light emitting module according to the embodiment of the present disclosure is described in terms of the emitting region.

Optionally, the light emitting module 110 may include at least two emitting arrays, and each emitting array serves as one emitting region.

The emitting array may include multiple light sources for light emission, for example, may include multiple semiconductor lasers, but not limited thereto. The emitting array may include other types of lasers according to actual application scenarios, to solve the problem of limited power of a single light source for light emission and increase the detection distance.

For a given DTOF lidar, such as a Vertical-Vavity Surface-Emitting Lase (VCSEL), the emission field of view is a×b in the conventional technology, where a horizontal axis is represented by a, and a vertical axis is represented by b. Optionally, the emitting region in the embodiment of the present disclosure may correspond to an n×n emitting array. For example, the emitting array may include n×n VCSELs, where n may be set as 3, 4, 5, or the like, depending on the actual situation. Each VCSEL is configured to output the emitted light to different regions on the detected target 150. In this case, the field of view of each VCSEL provided in the embodiment of the present disclosure is a/n×b/n, and an area corresponding to each VCSEL on the detected target 150 is reduced to 1/n² of the original, and the signal strength received on the surface of the detected target is increased to n² times the original. In this way, the energy originally occupying the entire field of view is concentrated on a smaller field of view, reducing the field of view corresponding to each emitting region, and increasing the energy received by the detected target per unit area and the number of received reflected light photons received, thereby achieving the energy concentration and improving the power density. Therefore, the detection distance of the detection device can be increased to a certain extent, and the applicability of the detection device can be improved.

In the short-distance detection, one or several regions of the n×n VCSELs output the emitted light once, which can reduce the energy of the laser and achieve the energy saving in the short-distance detection.

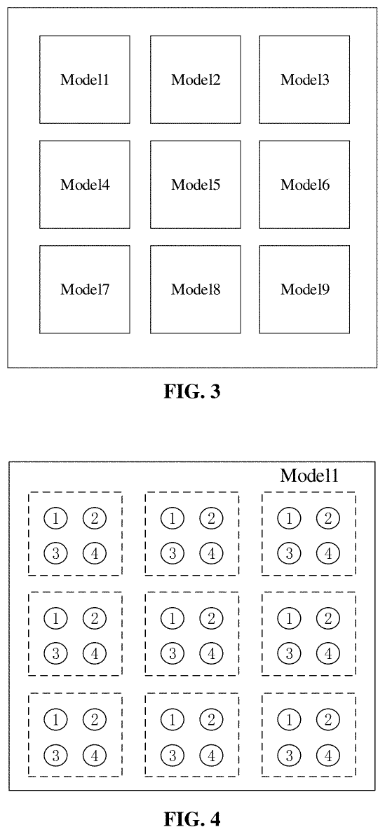

FIG. 3 is a schematic diagram showing an emitting region according to an embodiment of the present disclosure. As shown in FIG. 3, the emitting array may include 3×3 Models, and each Model may correspond to one VCSEL. In this case, the field of view of each VCSEL is a/3×b/3, and the area corresponding to each VCSEL on the detected target 150 is reduced to 1/32 of the original, and the signal strength received on the target surface of the detected target 150 is increased to 32 times the original.

In addition, it should be noted that the number of the emitting array is not limited in the present disclosure, which may be set as 3, 4, 6, or the like according to the actual application scenario. Further, the size of the emitting array is not limited in the present disclosure, which may be set as 3×3, 4×4, 5×5, or the like according to the actual application scenario.

Optionally, the light emitting module 110 may include one emitting array, the emitting array may be divided into at least two emitting modules, and each emitting module serves as one emitting region.

The emitting array may be formed by multiple emitting pixels. For example, a VCSEL may be used as the emitting array, and the emitting array may be divided into at least two emitting modules. Each emitting module is used as one emitting region and may include one or more emitting pixels to achieve secondary divisional emission, which has the same technical effect as the above and is not repeated herein. According to the actual application scenario, the corresponding light emitting module 110 may be selected to output the emitted light.

Optionally, the light emitting module 110 includes at least two emitting units, and at least some of the emitting units in the same emitting region output the emitted light at different times.

The emitting unit may be provided by an emitting pixel. In a case that each light emitting module serves as one emitting region, the light emitting module may include at least two emitting pixels. Optionally, in the case of the emission from the same emitting region, at least some of the emitting pixels may be selected to output the emitted light at different times, that is, time-sharing emission is performed on the basis of the divisional emission. In this way, the pressure on the driving caused by the increase in the pulse power of the light emitting module can be reduced, the maximum instantaneous current generated when the pulse is emitted can be reduced so that the driving current can be more gentle, and the heat dissipation burden of the light emitting module can be reduced, and thus improving the heat dissipation.

In addition, each emitting pixel may be used as a separate emitting region. Different pixel units or emitting regions may be combined into an emission group under the arrangement of the processing module. The emitting pixels in each emission group may simultaneously output the emitted light. Different emitting regions of the emitting array are combined into different emission groups, and different emission groups receive the emitting sequence instruction generated by the processing module, so as to obtain the distance data of the detected target containing the reflected light information for two times. The emitting pixels or emitting regions in the group may be combined in a specific shape, for example, in a regular shape such as linear, polyline, triangle and/or circle, or in an irregular and random shape. Correspondingly, the receiving end and the target region may establish a corresponding group relationship, which is not limited herein. In this way, the detection distance can be improved with the increase of the number of light emitting times, and the adaptability of the light source to the target region or the target can be adjusted adaptively by means of the arrangement shape.

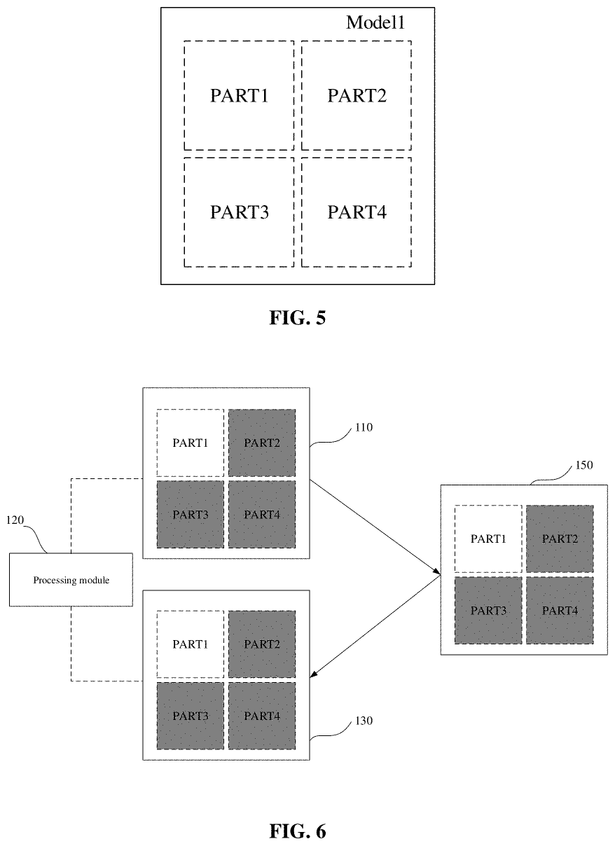

FIG. 4 is a schematic diagram showing an emitting region according to another embodiment of the present disclosure. As shown in FIG. 4, each Model may correspond to one VCSEL, and the emitting array may be divided into 9 emitting modules, each emitting module includes 4 emitting pixels. For different emitting modules, the emitting pixels are numbered in the same marking manner to distinguish from each other. Optionally, in the process that each emitting region outputs the emitted light, the emitting pixels with the same number respectively in the emitting modules may simultaneously perform emission according to the numbering of the emitting pixels in the emitting modules to output the emitted light.

It should be noted that the emitting sequence and the emission mode are not limited in the embodiments of the present disclosure, which are determined according to the emitting sequence instruction. As shown in FIG. 4, according to the emitting sequence instruction, in a first emission, the emitting pixels numbered 1 respectively in the emitting modules may perform emission at the same time to output a first emitted light. Further, in a second emission, the emitting pixels numbered 2 respectively in the emitting modules may perform emission at the same time to output a second emitted light. Next, a third emitted light and a fourth emitted light are outputted in sequence, and the above process is repeated for emission, but is not limited thereto.

Optionally, the light emitting module 110 may include at least two emitting units, and each emitting unit serves as one emitting region.

The emitting unit may be provide by an emitting pixel, that is, the light emitting module 110 may include at least two emitting pixels, and each emitting pixel serves as one emitting region. It should be noted that, the number of emitting units in each emitting region is not limited in the present disclosure, and the emitting region may include one or more emitting units.

FIG. 5 is a schematic diagram showing an emitting region according to another embodiment of the present disclosure. As shown in FIG. 5, each Model may correspond to one VCSEL. For each VCSEL, the VCSEL may be divided into 4 emitting regions including PART1 to PART4, to achieve the divisional emission, which has the same technical effect as the above and is not repeated herein. Compared with the solution of each emitting array serving as one emitting region, the divisional emission is performed based on the single VCSEL, so that the emitting region can be more concentrated. Further, for the single VCSEL used for the divisional emission, all IO interfaces may be arranged on the periphery of the chip. In this way, the case that some isolation space is required between VCSELs when using multiple VCSELs can be avoided, which may result in a certain distance between light emitting points, so that not all fields of view are covered. Therefore, compared with the existing solution of the single VCSEL being used for the emission without being divisional, the energy received by the detected target per unit area and the number of received reflected light photons can be increased with the detection device provided in the embodiment of the present disclosure, achieving the energy concentration and improving the power density, thereby increasing the detection distance of the detection device.

All the emitting units of the emitting module in this embodiment are arranged so that the light emitting positions are in the same plane without the stacking of different layers, which ensures that there is almost no difference between laser emitting positions of the emitting units, and further ensures the simplicity of the manufacturing process especially for the emitting end implemented by means of the VCSEL, which is important and related to whether the entire solution can be efficiently put into production.

The processing module 120 is configured to generate the emitting sequence instruction according to at least one of a function, a list, a number sequence, or a randomly generated sequence.

The manner of generating the emitting sequence instruction may be not limited in the embodiments of the present disclosure, which may be generated in a functional manner, or selected from a list and/or sequence, or may be generated randomly. The generated emitting sequence instruction may correspondingly have multiple emission manners such as sequential one-by-one emission, sequential multi-region emission, random single-region emission, and/or random multi-region emission. It should be noted that, the emitting sequence instruction may be generated in other manners according to actual application scenarios, and correspondingly may have other emission manners.

Optionally, the processing module 120 is further configured to: determine, according to the emitting sequence instruction, the receiving region corresponding to the reflected light each time, as a target receiving region; and acquire at least a part of target distance information according to time information of the target receiving region receiving the reflected light.

In a case that the light emitting module 110 performs the divisional emission, the light receiving module 130 may perform divisional reception. Since the light emitting module 110 controls at least two emitting regions to sequentially output the emitted light according to the emitting sequence instruction generated by the processing module 120, the processing module 120 may determine the receiving region corresponding to reflected light each time according to the emitting sequence instruction as the target receiving region, and further acquire at least a part of the target distance information according to the time information of the target receiving region receiving the emitted light. According to this method, in the case that the light emitting module 110 performs the divisional emission, the light receiving module 130 may perform divisional reception, and calculate the distance data of the detected target including the reflected light information for at least two times according to the data of the receiving regions, increasing the detection distance of the detection device, and improving the applicability of the detection device.

Optionally, the processing module 120 is further configured to set, according to the target receiving region, received signals of other receiving regions among the receiving regions than the target receiving region as a preset value.

In addition, in the process of performing the divisional reception, in order to avoid the interference of received signals in non-target receiving regions, the processing module 120 may set the received signals of other receiving regions among the receiving regions than the target receiving region to a preset value, for example 0, to shield the non-target receiving regions and reserve only the target receiving region. In this way, the processing process of the data of the non-target receiving region can be omitted when acquiring the data of the target receiving region, which can improve the work efficiency, and also can guarantee the detection accuracy to a certain extent.

Optionally, the processing module 120 is configured to generate a detected target map according to the emitting sequence instruction and a time when the reflected light is received each time, where the detected target map includes all distance data of the detected target.

In the process that the light emitting module 110 performs the divisional emission, the light receiving module 130 may receive reflected light each time by the divisional reception, acquire the time information of receiving the reflected light each time, and transmit the time information to the processing module 120. The processing module 120 may splice the received time information according to the emitting sequence instruction and the time information of receiving the reflected light each time to generate the detected target map, where the detected target map may include all the distance data of the detected target 150, from which the detection distance for the detected target 150 is acquired. In the case of short distance detection, some emitting regions emit the detection light at one time, and the processing module 120 acquires the data and calculates the distance to the target region or the target.

FIG. 6 is a schematic diagram showing divisional emission according to another embodiment of the present disclosure. As shown in FIG. 6, the light emitting module 110 includes a total of 4 emitting regions, PART 1 to PART 4. The light receiving module 130 includes a total of 4 receiving regions, PART 1 to PART 4, which are in one-to-one correspondence with those in the light emitting module. That is, the receiving region PART 1 is used to receive the reflected light reflected from the detected target 150 of the emitted light outputted from the emitting region PART 1. If the emitting sequence corresponding to the emitting sequence instruction generated by the processing module 120 is that the 4 emitting regions output the emitted light in the order of PART 1→PART 2→PART 3→PART 4, the processing module 120 firstly transmits the emitting sequence instruction to the light emitting module 110 and the light receiving module 130. For the light emitting module 110, the emitting region PART 1 firstly outputs the emitted light, then the emitting region PART2 outputs the emitted light, the emitting region PART 3 outputs the emitted light, and finally the emitting region PART 4 outputs the emitted light. For the light receiving module 130, for example, when the emitting region PART 1 performs the emission, the receiving region PART 1 receives the reflected light corresponding to the emitting region PART 1 and acquires the corresponding time information. In this case, the processing module 120 shields the receiving regions PART 2 to PART4, and sets the received data in the receiving regions PART 2 to PART4 to be 0. By this process, after completing one cycle, the processing module 120 acquires four times of time information respectively corresponding to the receiving regions PART 1 to PART 4, and superimposes the four times of time information to obtain a complete frame of distance information image, and further calculate the distance data of the detected target, thus the detection distance for the detected target can be obtained. The case of the short distance detection is not described in detail, which is similar to the above.

Optionally, the emitting module is a signal vertical cavity surface laser chip.

The vertical cavity surface laser chip is referred to as VCSEL for short, which is a semiconductor in which the laser is emitted perpendicular to the top surface, which is different from the edge-emitting laser in which the laser is emitted from the edge, where the edge-emitting laser is generally formed by a cut independent chip. It should be noted that the emitting module may be other types of lasers, which is not limited in the present disclosure.

Optionally, the light emitting module 110 is further configured to control, according to the emitting sequence instruction, one or more emitting regions to output the emitted light each time.

In the case that the light emitting module 110 includes multiple emitting regions, one or more emitting regions may output the emitted light each time. As shown in FIG. 6, the light emitting module 110 includes a total of 4 emitting regions, PART 1 to PART 4, and the order of outputting the emitted light may be that one emitting region outputs the emitted light each time, that is, the order of outputting the emitted light may be PART 1→PART 2→PART 3→PART 4. In addition, multiple emitting regions may output the emitted light each time, that is, the order of outputting the emitted light may be PART 1 and/or PART 2→PART 3 and/or PART 4. Other output manners may be adopted according to actual application scenarios, which is not limited in the present disclosure.

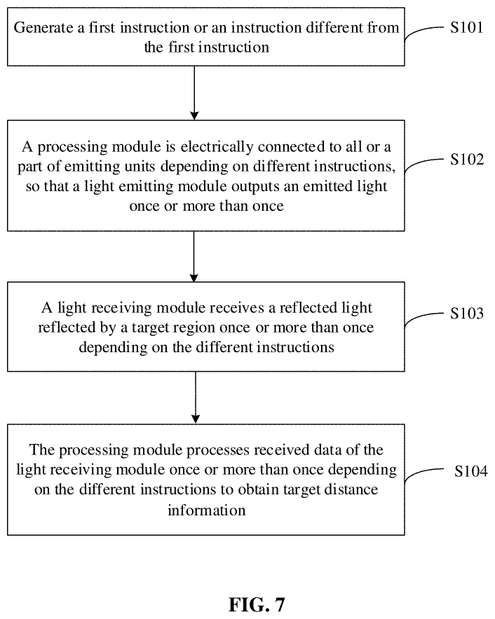

FIG. 7 is a schematic flowchart of a detection method according to an embodiment of the present disclosure. The method may be performed by the detection device described above, and the basic principle and technical effects of the method are the same as those of the corresponding device embodiments. For the sake of brief description, the parts not mentioned in this embodiment may be referred to the corresponding contents in the device embodiments. As shown in FIG. 7, the detection method includes the following steps S101 to S104.

In S101, a first instruction or an instruction different from the first instruction is generated.

In S102, a processing module is electrically connected to all or some of emitting units depending on different instructions, so that a light emitting module outputs an emitted light once or more than once.

In S103, a light receiving module receives a reflected light reflected from a target region once or more than once depending on the different instructions.

In S104, the processing module processes received data of the light receiving module once or more than once depending on the different instructions to obtain target distance information.

Optionally, the light emitting module includes at least two emitting arrays, and each emitting array serves as one emitting region.

Optionally, the light emitting module includes one emitting array, the emitting array is divided into at least two emitting modules, and each emitting module serves as one emitting region.

Optionally, the emitting module includes at least two emitting units, and at least some of the emitting units in the same emitting region output the emitted light at different times.

Optionally, the light emitting module includes at least two emitting units, and each emitting unit serves as one emitting region.

Optionally, the generated emitting sequence instruction includes: a mode instruction obtained by determination according to historical distance data or preset distance data.

Optionally, all emitting units or all emitting regions of the light emitting module output the emitted light at one time, and the processing module acquires one-time data of the light receiving module and outputs the distance information result.

Optionally, some of the emitting units or some of the emitting regions of the light emitting module output the emitted light once, and the processing module acquires the one-time data of the light receiving module and outputs the distance information result.

Optionally, some of the emitting units or some of the emitting regions of the light emitting module output the emitted light at least twice, and the processing module acquires the data of the light receiving module at least twice and outputs the distance information result.

The process that some of the emitting units or some of the emitting regions of the light emitting module output the emitted light at least twice and the processing module acquires the data of the light receiving module at least twice and outputs the distance information result may be performed by performing the following steps S101 to S104 as shown in FIG. 8.

In S101, an emitting sequence instruction is generated.

In S102, according to the emitting sequence instruction, at least two emitting regions sequentially output the emitted light.

In S103, according to the emitting sequence instruction, at least two receiving regions receive the reflected light of the emitted light at least twice that is reflected from the detected target.

In S104, according to the emitting sequence instruction, the data of the at least two receiving regions is acquired sequentially, and the distance data of the detected target including the reflected light information for at least twice is calculated.

Optionally, the light emitting module includes at least two emitting arrays, and each emitting array serves as one emitting region.

Optionally, the light emitting module includes one emitting array, the emitting array is divided into at least two emitting modules, and each emitting module serves as one emitting region.

Optionally, the emitting module includes at least two emitting units, and at least some of the emitting units in the same emitting region output the emitted light at different times.

Optionally, the light emitting module includes at least two emitting units, and each emitting unit serves as one emitting region.

Optionally, the generated emitting sequence instruction includes: an emitting sequence instruction generated according to at least one of a function, a list, a number sequence or a randomly generated sequence.

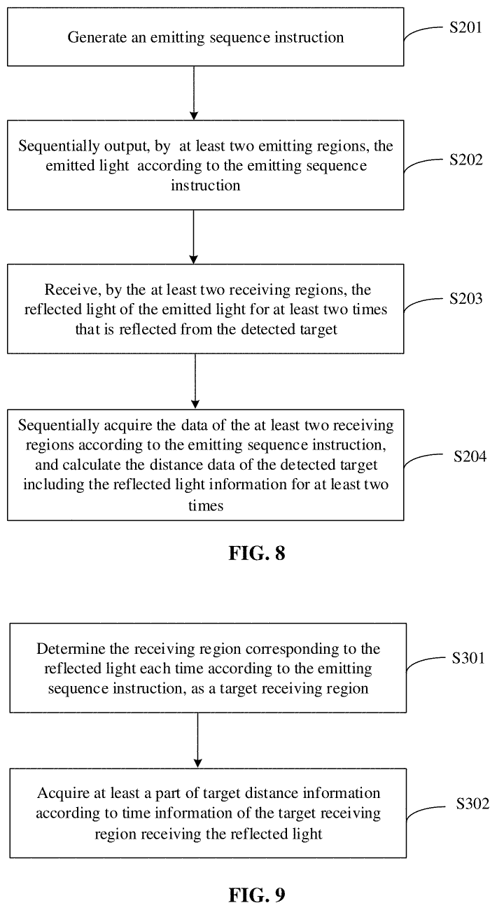

FIG. 9 is a schematic flowchart of a detection method according to another embodiment of the present disclosure. Optionally, as shown in FIG. 9, the above method further includes the following steps S201 and S202.

In S201, according to the emitting sequence instruction, the receiving region corresponding to reflected light each time is determined as a target receiving region.

In S202, according to time information of the target receiving region receiving the reflected light, at least a part of the target distance information is acquired.

Optionally, the method further includes: setting, according to the target receiving region, received signals of other receiving regions among the receiving regions than the target receiving region as a preset value.

Optionally, the process of sequentially acquire the data of the at least two receiving regions according to the emitting sequence instruction and calculating the distance data of the detected target including the reflected light information for at least two times includes: generating a detected target map according to the emitting sequence instruction and a time when the reflected light is received each time, where the detected target map includes all distance data of the detected target.

Optionally, the emitting module is a single vertical cavity surface laser chip.

Optionally, the process that the at least two emitting regions sequentially output the emitted light according to the emitting sequence instruction includes: controlling, according to the emitting sequence instruction, one or more emitting regions to sequentially output the emitted light each time.

The above method is applied to the detection device provided in the above embodiments, and the implementation principle and technical effect thereof are similar, which is not repeated herein.

It should be noted that, relational terms such as “first” and “second” herein are only used to distinguish one entity or operation from another entity or operation, and do not necessarily require or imply there is such actual relationship or sequence between these entities or operations. Moreover, terms “comprising”, “including” or any other variations thereof are intended to encompass a non-exclusive inclusion, such that a process, a method, an article or a device including a series of elements includes not only those elements, but also includes other elements that are not explicitly listed or inherent to such the process, method, article or device. Without further limitation, an element defined by a phrase “including a . . . ” does not preclude the presence of additional identical elements in a process, method, article or device including the element.

Preferred embodiments of the present disclosure are given in the above description, and are not intended to limit the present disclosure. For those skilled in the art, the present disclosure may have various modifications and changes. Any modifications, equivalents and improvements made in the spirit and principle of the present disclosure should be included in the protection scope of the present disclosure. It should be noted that similar numerals and letters refer to similar items in the following drawings. Therefore, if an item is defined in a drawing, the item is not required to be further defined and explained in subsequent drawings. Preferred embodiments of the present disclosure are given in the above description, and are not intended to limit the present disclosure. For those skilled in the art, the present disclosure may have various modifications and changes. Any modifications, equivalents and improvements made in the spirit and principle of the present disclosure should be included in the protection scope of the present disclosure.

1. A detection device, comprising: a light emitting module, a processing module and a light receiving module, the light emitting module having at least two emitting regions, the light receiving module having at least two receiving regions corresponding to the light emitting module, wherein
the processing module is configured to generate a first instruction to be electrically connected to all emitting units so that all the emitting units simultaneously output emitted light, wherein receiving units of the light receiving module are in one-to-one correspondence with the emitting units, and the processing module is configured to calculate distance data of a detected target according to data of the light receiving module, and
the processing module is further configured to generate an instruction different from the first instruction to be electrically connected to some of the emitting units so that the light emitting module outputs the emitted light once or more than once, and the light receiving module is configured to acquire reflected light information of a target region once or more than once, and the processing module is configured to acquire data of the receiving regions once or more than once, and calculate the distance data of the detected target comprising the reflected light information once or more than once.

2. The detection device according to claim 1, wherein
the processing module is configured to generate an emitting sequence instruction;
the light emitting module is electrically connected to the processing module and is configured to control, according to the emitting sequence instruction generated by the processing module, the at least two emitting regions to sequentially output the emitted light;
the light receiving module is electrically connected to the processing module and is configured to control, according to an emitting sequence instruction generated by the processing module, the at least two receiving regions to receive the reflected light of the emitted light for at least two times that is reflected from the detected target; and
the processing module is configured to: sequentially acquire the data of the at least two receiving regions according to the emitting sequence instruction, and calculate the distance data of the detected target comprising the reflected light information for at least two times.

3. The detection device according to claim 2, wherein
the light emitting module comprises one emitting array, and the emitting array is divided into at least two emitting modules, and each of the emitting modules serves as one of the emitting regions; or
the light emitting module comprises at least two emitting arrays, and each of the emitting arrays serves as one of the emitting regions.

4. The detection device according to claim 2, wherein the processing module is configured to generate the emitting sequence instruction according to at least one of a function, a list, a number sequence or a randomly generated sequence.

5. The detection device according to claim 4, wherein the processing module is further configured to: determine the receiving region corresponding to the reflected light each time according to the emitting sequence instruction, as a target receiving region; and acquire at least a part of target distance information according to time information of the target receiving region receiving the reflected light.

6. The detection device according to claim 5, wherein the processing module is further configured to: set, according to the target receiving region, received signals of other receiving regions among the receiving regions than the target receiving region as a preset value.

7. The detection device according to claim 2, wherein the processing module is configured to generate a detected target map according to the emitting sequence instruction and a time when the reflected light is received each time, wherein the detected target map comprises all distance data of the detected target.

8. The detection device according to claim 2, wherein the light emitting module is further configured to control, according to the emitting sequence instruction, one or more of the emitting regions to output the emitted light each time.

9. The detection device according to claim 1, wherein the processing module is configured to generate the first instruction or the instruction different from the first instruction according to distance information of the detected target.

10. The detection device according to claim 9, wherein the distance information of the detected target is historical detection distance information, and wherein in the detection device, the processing module is electrically connected to the light emitting module according to the first instruction or the instruction different from the first instruction, so that the light emitting module outputs the emitted light once or more than once, and the processing device is configured to acquire the data received by the light receiving device, and calculate the historical detection distance information.

11. The detection device according to claim 1, wherein the plurality of emitting units are divided into at least two emitting regions, and the plurality of receiving units are divided into at least two corresponding receiving regions.

12. The detection device according to claim 10, wherein a plurality of emitting units in a same emitting region are electrically connected to the processing module under the instruction different from the first instruction to output the emitted light at different times.

13. A detection method, comprising: a light emitting module, a processing module and a light receiving module, the light emitting module having at least two emitting regions, the light receiving module having at least two receiving regions corresponding to the light emitting module, wherein
the processing module is capable of generating a first instruction to be electrically connected to all emitting units so that all the emitting units simultaneously output emitted light, wherein receiving units of the light receiving module are in one-to-one correspondence with the emitting units, and the processing module calculates distance data of a detected target according to data of the light receiving module, and
the processing module is further capable of generating an instruction different from the first instruction to be electrically connected to some of the emitting units so that the light emitting module outputs the emitted light once or more than once, and the light receiving module acquires reflected light information of a target region once or more than once, and the processing module acquires data of the receiving regions once or more than once, and calculates the distance data of the detected target comprising the reflected light information once or more than once.

14. The detection method according to claim 13, wherein
the processing module generates an emitting sequence instruction;
the light emitting module is electrically connected to the processing module and is configured to control, according to the emitting sequence instruction generated by the processing module, the at least two emitting regions to sequentially output the emitted light;
the light receiving module is electrically connected to the processing module and is configured to control, according to an emitting sequence instruction generated by the processing module, the at least two receiving regions to receive the reflected light of the emitted light for at least two times that is reflected from the detected target; and
the processing module is configured to: sequentially acquire the data of the at least two receiving regions according to the emitting sequence instruction, and calculate the distance data of the detected target comprising the reflected light information for at least two times.

15. The detection method according to claim 14, wherein
the light emitting module comprises one emitting array, and the emitting array is divided into at least two emitting modules, and each of the emitting modules serves as one of the emitting regions; or
the light emitting module comprises at least two emitting arrays, and each of the emitting arrays serves as one of the emitting regions.

16. The detection method according to claim 14, wherein the processing module is configured to generate the emitting sequence instruction according to at least one of a function, a list, a number sequence or a randomly generated sequence.

17. The detection method according to claim 16, wherein the processing module is further configured to: set, according to the target receiving region, received signals of other receiving regions among the receiving regions than the target receiving region as a preset value.

18. The detection method according to claim 13, wherein the processing module generates the first instruction or the instruction different from the first instruction according to distance information of the detected target.

19. The detection method according to claim 18, wherein the distance information of the detected target is historical detection distance information, and wherein in the detection device, the processing module is electrically connected to the light emitting module according to the first instruction or the instruction different from the first instruction, so that the light emitting module outputs the emitted light once or more than once, and the processing device acquires the data received by the light receiving device and calculates the historical detection distance information.

20. The detection method according to claim 14, wherein the processing module is configured to generate a detected target map according to the emitting sequence instruction and a time when the reflected light is received each time, wherein the detected target map comprises all distance data of the detected target.
